(19) United States
(12) Patent Application Publication
(10) Pub. No.: US 2019/0209974 A1
(43) Pub. Date: Jul. 11, 2019

(54) IMPROVED FILTRATION MEMBRANE

(71) Applicant: Advanced Mem-Tech Ltd., Nes Tziona (IL)

(72) Inventors: Dikla ZADAKA-AMIR, Rehovot (IL); Gilad LANDO, Rishon Lezion (IL); Elizabeth ALEXANDER, Denver, CO (US); Elad MEGIDISH, Kiryat Gat (IL)

(73) Assignee: Advanced Mem-Tech Ltd., Nes Tziona (IL)

(21) Appl. No.: 16/326,230

(22) PCT Filed: Aug. 17, 2017
(86) PCT No.: PCT/IL2017/050912

§ 371 Date: Feb. 18, 2019

Related U.S. Application Data
(60) Provisional application No. 62/376,460, filed on Aug. 18, 2016.

(51) Int. Cl. B01D 69/02; B01D 61/02; B01D 61/14; B01D 65/08; B01D 65/02; C02F 1/44; C02F 3/12; B01D 67/00

(52) U.S. Cl. CPC B01D 69/02; B01D 61/025; B01D 61/14; B01D 65/08; B01D 65/02; C02F 1/441; B01D 71/34; C02F 3/1273; B01D 67/0088; B01D 2321/185; B01D 2325/06; B01D 2325/08; C02F 1/444

(57) ABSTRACT

The present disclosure is directed to membranes having improved performance parameters, specifically, to microfiltration, ultrafiltration, Nano filtration, reverse osmosis, submerged and bioreactor membranes having a portion with increased roughness (Ra) level.

### CROSS-REFERENCE TO RELATED APPLICATIONS

This application claims the benefit of pending PCT Application No. PCT/IL2017/050912, filed Aug. 17, 2017, which further claims priority from expired U.S. Provisional Application No. 62/376,460, filed Aug. 18, 2016, both which are incorporated herein by reference in their entirety.

### BACKGROUND

The present disclosure relates to membranes having improved performance parameters, specifically, to microfiltration, ultrafiltration, nano-filtration, reverse osmosis, having a portion with increased roughness (Ra) level.

A membrane is a layer of material which serves as a selective barrier when exposed to the action of a driving force. Some components are allowed passage by the membrane into a permeate stream, whereas others are retained by it and accumulate in the retentate stream.

There are significant differences in the design, purpose and materials of construction and properties of different membranes which include: Microfiltration (MF), Ultrafiltration (UF) Nanofiltration (NF) and Reverse Osmosis (RO).

Conventional cleaning methods of filtration membranes also differ significantly. Membranes can be cleaned physically and chemically. Physical methods are based on mechanical forces to dislodge and remove fouling agents from the membrane surface such as forward and reverse flushing (crossflow and backwash) and air sparging and take place at a relatively high frequency, while chemical cleaning takes place in a relatively low frequency (due to e.g., work stoppages, shortening the life of the membrane). Physical cleaning can be combined with chemical cleaning using basic alkali, acid and oxidizing chemicals, which weaken the cohesion forces between the surfaces and fouling agents.

These and other shortcomings of the available technologies are addressed by the proposed technology.

### SUMMARY

In an embodiment, provided herein is a filtration membrane having at least one surface portion with roughness (Ra) of between about 7 μm to 700 μm.

In another embodiment, provided herein is a method of improving a membrane performance parameter in reverse osmosis, ultrafiltration, nanofiltration, or Microfiltration membrane comprising the step of: roughening at least one surface portion of the membrane; and at predetermined time intervals, scouring the roughened surface of the membrane with bubbles and/or particles having average size of between about 0.1 mm and about 10 mm.

In yet another embodiment, the performance parameter improved by the membranes and methods described and claimed, is increased flow rate, increased membrane active surface, increasing time between cleanings, increasing membrane stiffness, inhibiting caking, increasing membrane permeability, giving better utilization or effectiveness of mechanical cleaning methods or a combination thereof.

### BRIEF DESCRIPTION OF THE DRAWINGS

The features of the increased surface roughness membrane and methods of use thereof, described herein, will become apparent from the following detailed description when read in conjunction with the figures, which are exemplary, not limiting, and in which:

FIG. 1, illustrates a profilometer scan of “smooth” membrane over 6 mm at the bottom of the membrane;

FIG. 2, illustrates a profilometer scan of “rough” membrane over 8 mm at the bottom of the membrane;

FIG. 3A illustrates the comparison of rough vs. smooth PES membrane as expressed in the decrease in flux as a function of time for mineralized (5%) water, with FIG. 3B illustrating the same comparison using a carboxylated poly(sulfone) (XPS) membrane further compared with distilled water;

FIG. 4, illustrates the comparison of rough vs. smooth PES membrane as expressed in the increase in pressure as a function of time to maintain constant flowrate in filtering municipal wastewater;

FIG. 5A illustrates the comparison of rough vs. smooth membrane as expressed in the increase in pressure as a function of time to maintain constant flowrate in filtering oily waste from an industrial (railway) site, with FIG. 5B illustrating the changes in permeability under the same conditions;

FIG. 6A, illustrates the comparison of rough vs. smooth membrane as expressed in the increase in pressure as a function of time to maintain constant flowrate in filtering wastewater from an agricultural (fruit washing) site, with FIG. 6B illustrating the changes in permeability under the same conditions;

FIG. 7A illustrates the comparison of rough vs. smooth membrane as expressed in the decrease in permeability as a function of time in filtering wastewater from an industrial site, with FIG. 7B illustrating the changes in pressure required t to maintain constant flowrate under the same conditions; and

FIG. 8, illustrates the comparison of rough vs. smooth MBR membrane as expressed in the increase in pressure as a function of time to maintain constant flowrate in filtering municipal wastewater.

While the disclosure is amenable to various modifications and alternative forms, specifics thereof have been shown by way of example in the drawings and will be further described in detail herein below. It should be understood, however, that the intention is not to limit the disclosure to the particular embodiments described. On the contrary, the intention is to cover all modifications, equivalents, and alternatives.

### DETAILED DESCRIPTION

Provided herein are embodiments of membranes having a portion with increased roughness (Ra) level for use in microfiltration, ultrafiltration, nano-filtration, reverse osmosis.

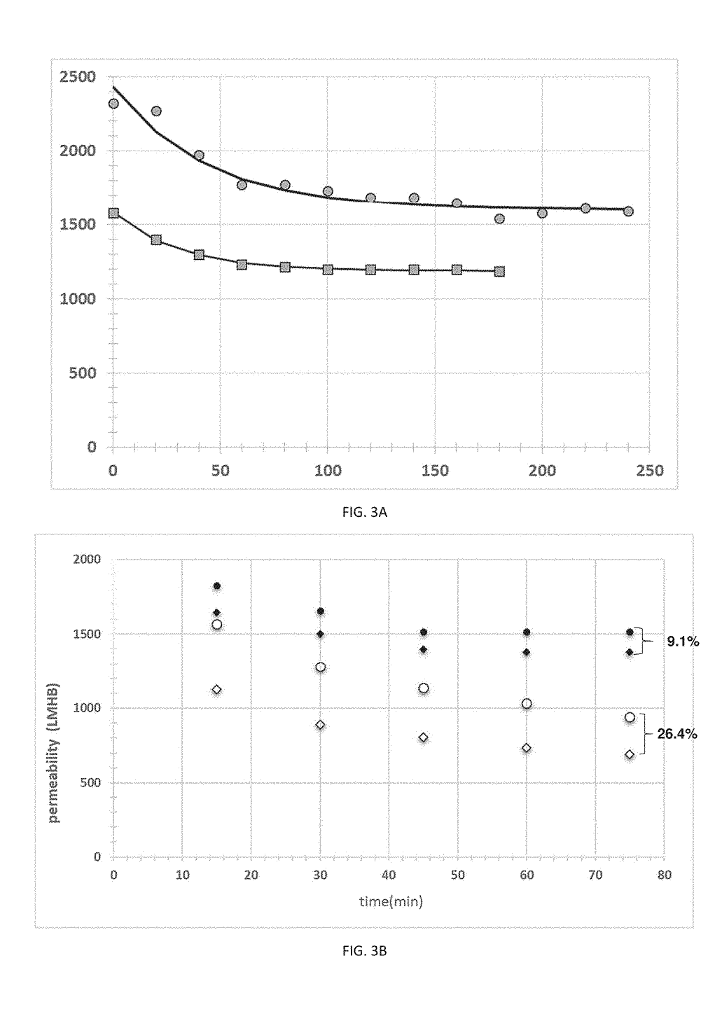

Although not bound by theory, it is stipulated that increasing surface roughness as described herein can improve the membrane performance by collectively or alternatively; increasing the active filtering surface area, improving mechanical cleaning, structuring fouling and foulants, including caking from adhering to the surface in a manner that will reduce the surface area of the membrane. Further, the increase in surface roughness may result in changing membrane elasticity or a combination of the foregoing. As illustrated by FIGS. 3-8, increasing surface roughness may further result in increased flow rate over time, increasing time between cleanings, increasing membrane stiffness, structuring salt caking, increasing membrane permeability, or a combination thereof. In addition, increasing the surface roughness can be done regardless of the material forming the membrane.

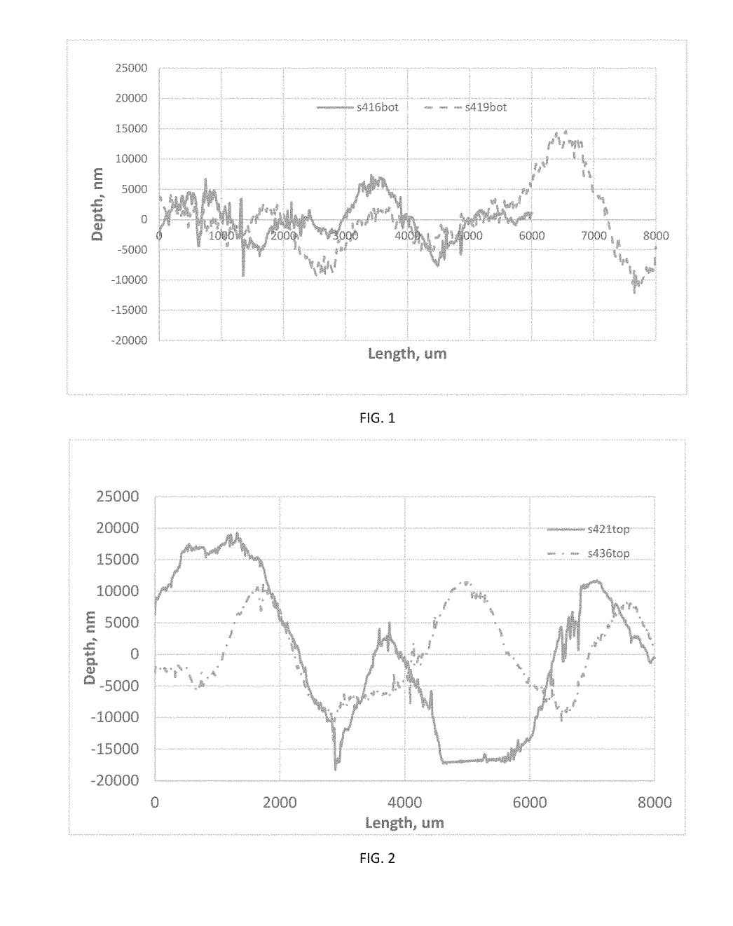

Accordingly and in an embodiment, provided herein is a filtration membrane having at least one surface portion with surface roughness (Ra) of between about 7 μm and about 700 μm. In an embodiment, “Roughness,” “surface roughness (Ra),” or like terms refer to, on a macroscopics and microscopic level or below, to an uneven or irregular surface condition, such as an average root mean squared (RMS) roughness or RMS roughness described below. As used herein, “roughness”, or “surface roughness” (or Ra), refer in an embodiment, to the arithmetic mean roughness measured using profilometer scan over a given length of the membrane and averaging the readings' deviation from a center plane line. As shown in FIGS. 1 and 2, the surface roughness of a “wavy” membrane is substantially larger than that of a “smooth” membrane.

The term “surface smoothness/roughness” may denote a property of the material's surface to be smooth or rough. An adequate “surface smoothness/roughness” may be achieved by adopting the materials' “mass density” at the surface, but also mechanical (e.g. polishing, corrugation, etc.) or chemical surface modifications as well as surface coatings may yield in an adequate modification of the “surface smoothness/roughness”. Such a “surface smoothness” may enhance laminar flow of a liquid passing by, whereas “surface roughness” may enhance or promote turbulent flow of a liquid passing by, as well as modify surface elasticity. The smoothness/roughness may also limit or prevent cell adhesion to the surface, pore occlusion.

Furthermore, “Waviness” or like terms (e.g., ‘wavy’), refers for example, to the maximum height variation from the highest point to the lowest point of a single-side or surface of the membrane sheet, not including front-to-back thickness variation, when the membrane sheet is laid on a flat measuring table. Waviness represents the overall curvature of a membrane sheet, or alternatively, the membrane's deviation from flatness. The waviness can be caused by, for example, forming processes, added materials (whether the same or different material than the material used to form the membrane itself), and like considerations, or combinations thereof. Waviness is a long-wave variation in the sample surface height, up to and including the entire dimensions of the sample.

In an embodiment, the at least one surface portion present in the membranes having at least a portion with increased surface roughness (Ra) can define an elevated pattern. The pattern can be elevated from a common plane or, in certain circumstances from the side opposite the rough surface portion, or in other circumstances, raised from the portions of the membrane that are not rough, but rather, are smooth (e.g., having mean Ra values of less than 200 nm). Likewise, the pattern can be random or non-random or corrugated.

The term “corrugated pattern” includes a sinusoidal, rectangular, trapezoidal or ribbed corrugated cross-sectional configuration and a “corrugation” is considered to comprise a pair of spaced side portions and an intermediate portion extending between the side portions. The same corrugation hence defines a valley when viewed from one side of the membrane and a peak or raised formation when viewed from the opposite side of the membrane. Adjacent corrugations hence have a side portion in common.

Non-random patterns can have fixed or variable periodicity (referring to any periodic characteristic of the elevated surface). Furthermore, the term “fixed periodicity” and/or “variable periodicity” is intended to refer to the degree center-to-center spacing by which each of an array of interspersed elevations, protrusions, rails, or peaks; or dimples, indents, channels, or valleys is separated. In the event a specific numerical value for a periodicity of distribution is provided herein, a margin of error of ±20 percent may be assumed. For example, variable periodicity may further define a fractal dimension (D) between 1.1 and 4.

For example, the elevated pattern in the membranes having at least a portion with increased surface roughness (Ra) can define a sinusoidal cross section, having general formula represented by depth (nm)=R_{z}·sin(x_{μm}/A)
wherein: Rz—maximum distance between the center plane and the highest peak in nm;)
   x μm—distance from start of scan in μm; and
   A—factor relating to the number of repeating elevations and valleys

Likewise, the elevated pattern in the membranes having at least a portion with increased surface roughness (Ra) can defines a square wave. As indicated, the patterns in the membranes having at least a portion with increased surface roughness (Ra) described, can form channels that are either continuous or discontinuous spanning the rough surface portion of the “rough side” of the membrane. The distance between any two adjacent channels can be fixed or vary between about 0.5 mm (500 μm) and about 10 mm (10,000 μm), for example, between about 1 mm (1,000 μm) and about 7 mm (7,000 μm). Further, the depth of the channel or the maximum distance between peak and valley, can be between about 0.02 (20 μm) mm and about 2.0 mm (2,000 μm), for example, between about 0.04 mm (40 μm) and about 1 mm (1,000 μm).

When formed, the channels in the membranes having at least a portion with increased surface roughness (Ra) can be vertical, horizontal or at an angle or combination to a membrane base, membrane top or any other point of reference. For example, the channels in the membranes having at least a portion with increased surface roughness (Ra) can be vertical, horizontal or at an angle to the flow direction of the fluid filtered. Further, as indicated, the channels can be continuous or discontinuous across the portion with increased roughness. Moreover, the channels can be configured to run in parallel to the predetermined flow direction of bubbles and/or particles used to scour the rough surface portion of the membrane.

The surface roughness of the membrane can be increased, or in the methods provided herein, the step of ‘roughening’, can be performed using any appropriate method. In an embodiment, “Roughen,” “roughening,” or like terms refer to, for example, to make at least one portion of the membrane sheet rough or rougher, or having an uneven or bumpy surface that is greater than the surface prior to, for example, etching treatment (in other words, removing membrane material), or adding material that can be the same or different than the material forming the base membrane.

For example, the surface roughness in the membranes having at least a portion with increased surface roughness (Ra) can be formed, or roughened, by a material different than the membrane material. That material can be, for example, a support material membrane folding or in other embodiments, by adding membrane material to the at least one surface portion, removing surface material from the at least one surface portion (e.g., by etching using a mask of given pattern), operably coupling the added material that is, in certain circumstances, different than the membrane base material, or a combination comprising the foregoing or addition of organic or inorganic nanomaterials.

Material added can be added by additive manufacturing and be printed onto the membrane that can be used as a substrate for the 3D printing. Any printed pattern can be added to the surface portion with increased roughness as dots, protrusions, lines (round tip or angular), or any pattern. Using additive manufacturing, other methods can be used to add the desired pattern. Accordingly, a removable mask can be coated onto the membrane and using acid, a portion pattern can be removed or etched. Additionally, or alternatively, the support material on which the membrane is coated can be rough, or likewise, the coating roll can be asymmetrical or made/coated from different metallic and nonmetallic materials, not smooth, corrugated or patterned as described herein.

As indicated, surface roughness can be formed with materials other than the membrane material and may also have different stiffness properties than the membrane material. Accordingly, increasing surface roughness in the membranes having at least a portion with increased surface roughness (Ra) can have a higher Young's modulus and/or a higher tensile strength than the material forming the membrane and be stiffer than the membrane itself. For example, the tensile strength of the membrane can be between about 0.5 MPa and about 5.0 MPa, while the added material roughening the portion can have a tensile strength of between about 5.0 MPa and about 15 MPa. Similarly, Young's modulus of the membrane can be between about 10 MPa and about 50 MPa, while the added material roughening the portion can have a Young's modulus of between about 45 MPa and about 200 MPa.

The membranes thus formed can be, for example, flat sheet membrane, or a tubular membrane, or a spiral wound membrane. Each can be used as reverse osmosis membrane, ultrafiltration membrane, nanofiltration membrane, microfiltration, submerged or bioreactor membrane or a combination thereof. Moreover, the membranes can be used, for example, for food and drink filtering, pre-and post reverse osmosis (RO) filtering, (industrial) wastewater separation, oil separation, removing suspended particles from liquid streams, and the like.

The term “coupled”, including its various forms such as “operably coupling”, “coupling” or “couplable”, refers to and comprises any direct or indirect, structural coupling, connection or attachment, or adaptation or capability for such a direct or indirect structural or operational coupling, connection or attachment, including integrally formed components and components which are coupled via or through another component or by the forming process. Indirect coupling may involve coupling through an intermediary member or adhesive, or abutting and otherwise resting against, whether frictionally or by separate means without any physical connection.

In an embodiment, the membranes having at least a portion with increased surface roughness (Ra) can be used to facilitate the methods provided. Accordingly, provided herein is a method of improving a membrane performance parameter in reverse osmosis, ultrafiltration, nanofiltration, or microfiltration membrane comprising the step of: roughening at least one surface portion of the membrane; and at predetermined time intervals, scouring the roughened surface of the membrane with bubbles and/or particles having average size of between about 0.1 mm and about 10 mm. Alternatively or additionally, the membrane having at least a portion with increased surface roughness (Ra) can be subject to cross-flow (forward flushing) in order to, for example, produce turbulent local points/areas, which can be configured to form shearing eddies on the membrane surface and thereby remove foulants. The foulants removed can be biofoulants, organic foulants and/or inorganic foulants based on their biological and chemical characteristics.

Example of biofoulants which removal is facilitated using the roughened membranes and methods provided herein, can be bacteria or flocs and their metabolites whose deposition, adherence, growth and metabolism on the membrane results in fouling. Likewise, organic foulants can be, for example, biopolymers, e.g., polysaccharides and proteins, as well as biopolymer clusters (BPC), which deposition on the membrane results in a decline of membrane permeability. Additionally, ‘Inorganic foulants’ refers to a group of inorganic substances that precipitate onto the membrane surface or into the membrane pores, resulting in membrane fouling. Examples of such substances include cations and anions such as Ca²⁺, Mg²⁺, Fe³⁺, Al³⁺, SO4⁻², PO4⁻³, CO3⁻², OH⁻, and the like, or a composition comprising the foregoing. Inorganic fouling is also termed “mineral scaling” caused mainly by crystallization and particulate fouling and play critical roles during inorganic membrane fouling. In crystallization, precipitation of ions is the pathway to deposition at the membrane surface. Conversely, particulate fouling can be caused by the deposition of colloidal particulate matter (i.e., particulates having average particle size of less than about 3.0 μm), following convective transportation in the filtered liquid to the membrane surface. In an embodiment, the roughened membranes and methods described herein are effective in reducing the decrease in permeate flux over time (see e.g., FIGS. 5B, 6B, and 7A), as well as the increase in the pressure required to maintain constant flow (in other words, hydraulic resistance). [See e.g., FIGS. 5A, 6A, 7B]

The term “hydraulic resistance” is intended to be defined broadly to include substantially any hydraulic impediment, pressure drop, resistance, or other flow slowing or controlling component, for example the deposition of foulant on the surface of the membranes.

Reverse osmosis refers to the separation process using pressure to force a solvent through a membrane retaining the solute on one side and allowing the pure solvent to pass to the other side. More formally, it is the process of forcing a solvent from a region of high solute concentration (high chemical potential μ) through a membrane to a region of low solute concentration (low chemical potential) by applying a pressure in excess of the osmotic pressure resulting from the difference in concentration. This is the reverse of the normal osmosis process, which is the natural movement of solvent from an area of low solute concentration, through a membrane, to an area of high solute concentration when no external pressure is applied. The membrane here is semi permeable, meaning it allows the passage of solvent but not of solute.

Performance of a water filtration systems may be measured by one or more of various parameters depending on the specific application. One parameter which may be considered is recovery rate, meaning the ratio of permeate produced per unit volume of feed water. A higher recovery rate provides a lower volume of retentate which must be discharged or treated further. Another parameter which may be considered is the energy cost of aeration. Many immersed membrane systems for example, use aeration, or air scouring, to inhibit membrane fouling. The energy required to aerate the membrane units is a significant annual expense and a significant component of the life cycle cost of a membrane system. Another parameter which may be considered is the fouling rate of the membranes. The rate at which the membranes foul affects how long a membrane unit will last before it needs to be replaced and the amount of chemical cleaning or aeration that may be required to keep the unit operating at an acceptable permeability or flux. Membrane fouling is related to many factors including the effectiveness of aeration and backwashing and the concentration of solids in the liquid on the feed or retentate side of the membranes. These and other performance parameters can be improved using the methods described herein.

Another parameter to measure membrane performance can be flux. The term “flux” or “permeate flow” (or flux), which can be used interchangeably, denotes the flow of fluid across the membrane, i.e. through the pores of the membrane. That is, it denotes the volumetric rate of flow of the permeate through the membrane. Permeate flow is usually given in terms of volume per unit membrane area per unit time as liters/m²/h (LMH).

In an embodiment, the compressed gas bubbles can be any appropriate gas for the given application, for example, air bubbles, CO₂ bubbles, N₂ bubbles, O₂ bubbles, noble gasses or a gas comprising one or more of the foregoing. Further, the particle used in the cleaning can be, for example: a glass bead, silica, dust, plastic, polymer, rubber, latex, porous particles or a combination of particles comprising the foregoing.

Furthermore, granular material, for example silica particles having an average particle size (volume average mean particle diameter, D_{3,2}), of between about 0.1 mm and about 10 mm, directed from one end of the roughened portion of the membrane to the opposite end can be used. The particulate matter used can be, for example silica particles, glass beads, granular activated carbon (GAC), poly(ethylene glycol).

### EXAMPLES

### General

The membranes were tested in a system based on close pressure cell having an inlet for the concentrate and outlet point, via the membrane for the permeate. Constant pressure of 0.5 bar (about 0.49 Atm.) is imposed at the membrane face.

### Permeability Test

Permeability is measured after distilled water is passed through the membrane for 30 minutes, whereby permeate is collected for 1 minute. Permeability was calculated from the flow, net area of the membrane in the pressure cell and pressure data using the following relationship:

Permeability(L/[m²*hours*bar])=Flow(ml/min)*K1/Pressure(bars)

Where: K1=0.001 L/ml*60 min/hr*10,000 cm²/m²*1/13 cm²=46.15 m⁻²

For each test, two submerged smooth membranes sheets (A4-sized) and two roughened membrane sheets of the same size were prepared. All membranes had a pore size of 0.04 micron (150 KD cutoff). The membrane elements were placed in a submerged test system with the treated water or wastewater. As shown in FIGS. 3-8, the roughened membrane elements exhibited lower trans membrane pressure (TMP) or higher working fluxes at the same TMP, indicating that roughened membranes can filter the same amount of water while applying less pressure or while using smaller membrane area.

### Example 1—Inorganic Foulant

Turning now to FIG. 3A, illustrating the comparison of rough vs. smooth membrane made from commercially available poly(ethersulfone) (PES) as expressed in the decrease in flux as a function of time for water containing salt (˜5%) water. As illustrated roughened membrane (round symbols, upper curve), under the same pressure, given in volume per unit membrane area per unit time as liters/m²/h (LMHB) shows higher permeate flow at any time point of the test.

Similar phenomenon is illustrated in FIG. 3B, using carboxylated poly(sulfone) membrane and comparing the filtration of mineralized water (5%, open symbols) to distilled water (close symbols) with smooth (diamond symbol) and wavy (round symbol) membranes.

Here too, it is evident that at every observation point, wavy, rough membrane illustrates better flowrate.

Not to be bound by theory, it is assumed that the roughened membrane prevents, mitigates, eliminates and/or inhibiting (all of which are encompassed by the term inhibiting as used in this document), the formation of mineral scaling and caking of the salt on the face of the membrane.

A table comparing membrane performance and the flow improvement using the rough, wavy membrane is shown in Table I:

TABLE I
Filtration comparison of the effect of smooth vs. rough membranes
formed from various materials on flow rates as a function of time:

| | Permeability | Average | Improvement |
|---|---|---|---|
| | (LMHB) | (LMHB) | (%) |
| XPS RMM membrane | | | |
| Smooth | 1720/1880 | 1800 | 17.5 |
| Rough | 2012/2220 | 2116 | |
| XPS MBR membrane | | | |
| Smooth | 760/920 | 840 | 61 |
| Rough | 1272/1433 | 1353 | |
| PES RMM membrane | | | |
| Smooth | 951/848 | 900 | 80 |
| Rough | 1576/1672 | 1624 | |
| PS MBR membrane | | | |
| Smooth | 479/646 | 563 | 55 |
| Rough | 841/899 | 870 | |
| PVDF MBR membrane | | | |
| Smooth | 110/138 | 124 | 87 |
| Rough | 250/214 | 232 | |

Legend:
RMM—Re-Mineralization membrane, a post treatment processing using reverse osmosis in desalination, to filtered water to re-mineralize the water to a predetermined level
MBR—Membrane Bioreactor, referring to the combination of equipment capable of, for example, microfiltration or ultrafiltration with a suspended growth bioreactor.
XPS—Carboxylated poly(sulfone)
LMHB—volume per unit membrane area per unit time in liters/m²/h
PVDF—Poly(vinylidene fluoride)
PS—Poly(sulfone)

As the table shows, regardless of the material forming the membrane, using roughened membrane surface causes an increase in permeate flow from as little as about 17.5% in membranes formed from XPS, to as much as 87% in Poly(vinylidene fluoride) (PVDF).

### Example 2, PES Membrane Filtration of Municipal Wastewater

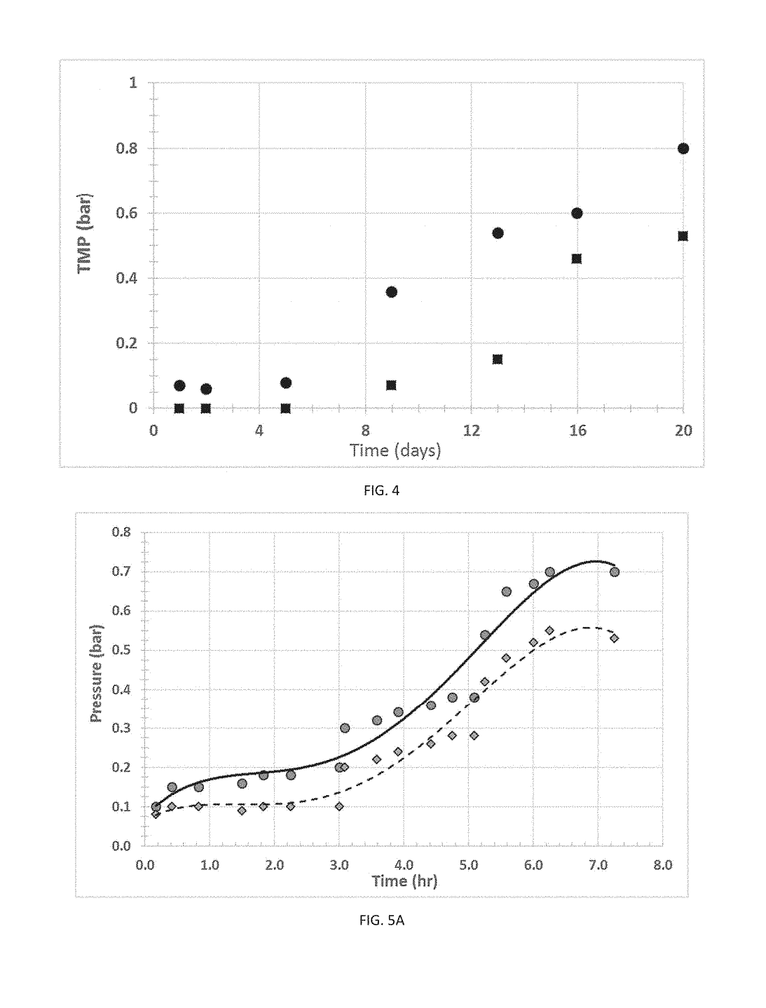

Turning now to FIG. 4, illustrating the comparison of rough vs. smooth commercially available poly(ethersulfone) (PES) membrane as expressed in the increase in pressure as a function of time to maintain constant flowrate in filtering municipal wastewater. As in example 1, roughened membrane (square symbols) shows lower trans-membrane pressure at each point in time.

### Example 3—Organic Oil-Based Foulants

Turning now to FIG. 5A illustrating the comparison of rough vs. smooth CPS membranes (see e.g., Ex. 1) as expressed in the increase in pressure, or hydraulic resistance as a function of time to maintain constant flowrate in filtering oily waste from an industrial (railway) site, with FIG. 5B illustrating the changes in permeate flow under the same conditions. Here too, roughened membranes (diamonds) (see e.g., FIG. 2) show lower hydraulic resistance and higher permeate flow at each point.

### Example 4—Organic Biofoulants

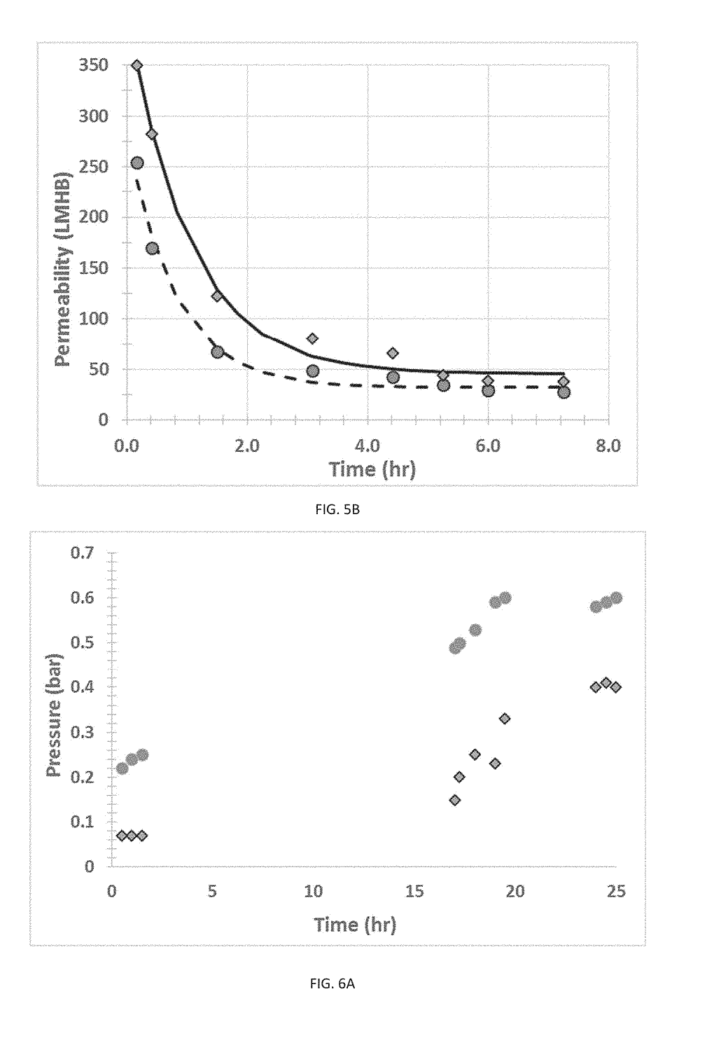

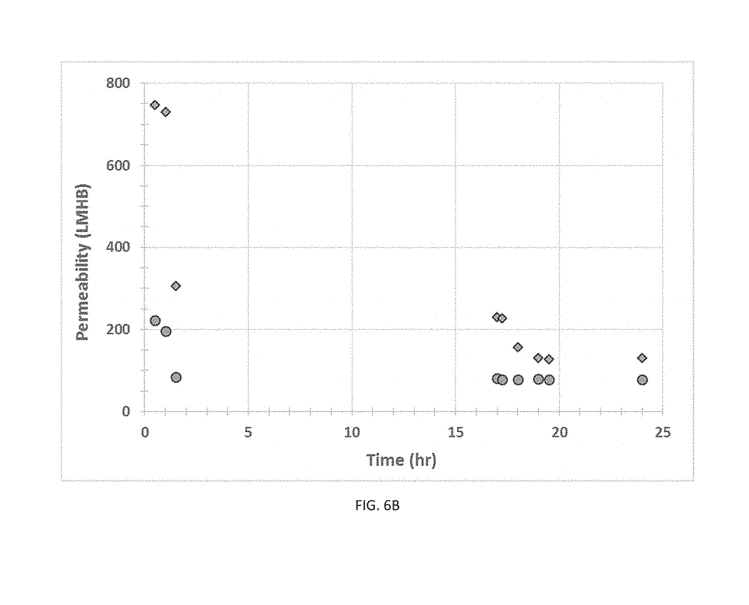

Turning now to FIG. 6A, which illustrates the comparison of rough (diamonds) vs. smooth (round) CPS membrane as expressed in the increase in hydraulic resistance as a function of time to maintain constant flowrate in filtering wastewater from an agricultural site resulting from washing fruit, with FIG. 6B illustrating the changes in permeate flow under the same conditions. Similar to the previous examples, here too, roughened membranes show lower hydraulic resistance and higher permeate flow at each point.

### Example 5—Industrial Wastewater

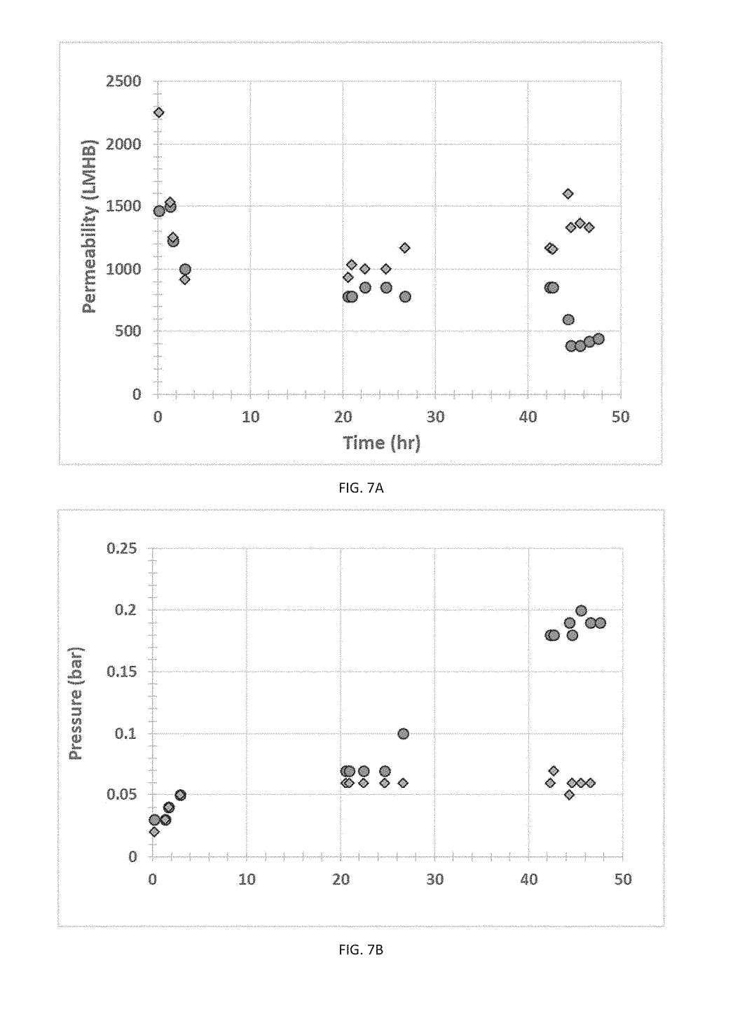

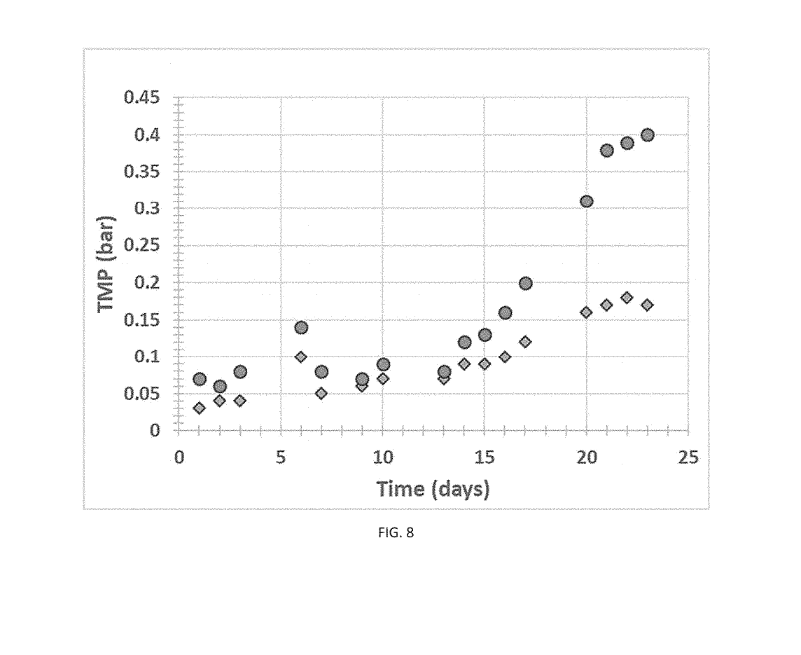

Turning now to FIG. 7A, which illustrates the comparison of rough (diamonds) vs. smooth (round) CPS membranes, as expressed in the decrease in permeate flow as a function of time in filtering waste from an industrial (toxic waste containing mainly 7% of dissolved slats and metals), with FIG. 7B illustrating the changes in hydraulic resistance or TMP required to maintain constant flowrate under the same conditions. As illustrated in FIGS. 7A, 7B, roughened membranes show lower hydraulic resistance and higher permeate flow at each point.

### Example 6—MBR of Municipal Wastewater

Turning now to FIG. 8, which illustrates the comparison of rough (diamonds) vs. smooth (round) CPS MBR membranes, as expressed in the increase in trans-membrane pressure (or hydraulic resistance) as a function of time to maintain constant flowrate in filtering municipal wastewater. As in previous examples, roughened membranes show lower hydraulic resistance at each point.

For the purposes of the present disclosure, directional or positional terms such as “top”, “bottom”, “upper,” “lower,” “side,” “front,” “frontal,” “forward,” “rear,” “rearward,” “back,” “trailing,” “above,” “below,” “left,” “right,” “radial ,” “vertical,” “upward,” “downward,” “outer,” “inner,” “exterior,” “interior,” “intermediate,” etc., are merely used for convenience in describing the various embodiments of the present disclosure.

The terms “first,” “second,” and the like, herein do not denote any order, quantity, or importance, but rather are used to denote one element from another. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the membrane(s) includes one or more membrane).

Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

Accordingly and in an embodiment, provided herein is a filtration membrane having at least one surface portion with roughness (Ra) of between about 7 μm and 700 μm, wherein (i) the at least one surface portion defines an elevated or a corrugated pattern, (ii) the elevated pattern has fixed, or (iii) variable periodicity, (iv) the corrugated pattern defines a sinusoidal cross section, wherein (v) the elevated pattern defines a square wave, (vi) and/or form channels spanning the at least one surface portion, wherein (vii) the distance between adjacent channels is between about 1 mm and about 10 mm, (viii) with the channel depth being between about 0.01 mm and about 2 mm, wherein (ix) wherein when assembled, the channels are vertical, horizontal or at an angle to a membrane base, wherein (x) the surface roughness is formed (e.g., roughened) by a different material than the membrane-forming material, (xi) the different material different than the membrane material has a higher Young's modulus and/or higher tensile strength than the material forming the membrane, wherein (xii) the at least one rough surface portion is formed by adding membrane material to the at least one surface portion, removing surface material from the at least one surface portion, or a combination comprising the foregoing, and/or (xiii) by coupling the material different than the membrane material, or a combination comprising the foregoing, (xiv) forming a flat sheet membrane, a hollow fiber (in other words, micro-thin tubules with porous walls), a tubular membrane, or a spiral wound membrane, wherein (xv) the membrane is a reverse osmosis membrane, ultrafiltration membrane, microfiltration, nanofiltration membrane, submerged or bioreactor membrane, or a combination thereof.

In another embodiment, provided herein is a method of improving a membrane performance parameter in reverse osmosis, ultrafiltration, nanofiltration, or bioreactor membrane comprising the step of: roughening at least one surface portion of the membrane; and at predetermined time intervals, scouring the roughened surface of the membrane with bubbles and/or particles having average size of between about 0.1 mm and about 10 mm directed from one end of the roughened portion of the membrane, wherein (xvi) the at least one surface portion is adapted to have roughness (Ra) of between about 7 μm and 700 μm, wherein (xvii) the at least one surface portion is roughened to define an elevated or a corrugated pattern, (xviii) the elevated portion has fixed periodicity, wherein (xix) the corrugated pattern defines a sinusoidal cross section, wherein (xx) the step of roughening comprises adding a membrane material to the at least one surface portion, removing surface material from the at least one surface portion, or a combination comprising the foregoing, and/or (xxi) coupling a different material than the membrane material, wherein (xxii) the corrugation is adapted to form channels in parallel to the direction the bubbles and/or particles scour the roughened portion of the membrane, wherein (xxiii) the bubbles are air bubbles, CO₂ bubbles, N₂ bubbles, O₂ bubbles or a gas comprising one or more of the foregoing, and/or (xxiv) wherein the particle is a glass bead, silica, dust, plastic, polymer, porous particles, rubber, latex or a combination of particles comprising the foregoing, wherein (xxv) the performance parameter is increased flow rate over time, increasing time between cleanings, increasing membrane stiffness, inhibiting salt caking, increasing membrane permeability, or a combination thereof.

While in the foregoing specification the membranes having a portion with increased roughness (Ra) level described herein have been described in relation to certain embodiments, and many details are set forth for purpose of illustration, it will be apparent to those skilled in the art that the disclosure of the membranes having a portion with increased roughness (Ra) level are susceptible to additional embodiments and that certain of the details described in this specification and as are more fully delineated in the following claims can be varied considerably without departing from the basic principles of this invention.

What is claimed:

1. A filtration membrane having at least one surface portion with roughness (Ra) of between about 7 μm and 700 μm.

2. The membrane of claim 1, wherein the at least one surface portion defines an elevated or a corrugated pattern.

3. The membrane of claim 2, wherein the elevated pattern has fixed periodicity.

4. The membrane of claim 2, wherein the elevated pattern has variable periodicity.

5. The membrane of claim 2, wherein the corrugated pattern defines a sinusoidal cross section.

6. The membrane of claim 2, wherein the elevated pattern defines a square wave.

7. The membrane of claim 2, wherein the elevated pattern form channels spanning the at least one surface portion.

8. The membrane of claim 7, wherein the distance between adjacent channels is between 1 mm and 10 mm.

9. The membrane of claim 8, wherein the channel depth is between about 0.01 mm and about 2 mm.

10. The membrane of claim 8, wherein when assembled, the channels are vertical, horizontal or at an angle or their combination, to a membrane base.

11. The membrane of claim 1, wherein the surface roughness is formed by a material different than the membrane material.

12. The membrane of claim 11 wherein the different material different than the membrane material has a higher Young's modulus and/or higher tensile strength than the material forming the membrane.

13. The membrane of claim 1, wherein the at least one rough surface portion is formed by adding membrane material to the at least one surface portion, removing surface material from the at least one surface portion, or a combination comprising the foregoing.

14. The membrane of claim 11, wherein the at least one rough surface portion is formed by coupling the material different than the membrane material, or a combination comprising the foregoing.

15. The membrane claim 1, forming a flat sheet membrane, a tubular membrane, a hollow fiber or a spiral wound membrane.

16. The membrane of claim 15, wherein the membrane is a reverse osmosis membrane, ultrafiltration membrane, microfiltration, nanofiltration membrane, submerged or bioreactor membrane or a combination thereof.

17. A method of improving a membrane performance parameter in reverse osmosis, ultrafiltration, nanofiltration, microfiltration submerged or bioreactor membrane comprising the step of:
a. roughening at least one surface portion of the membrane; and
b. at predetermined time intervals, scouring the roughened surface, of the membrane with bubbles and/or particles having average size of between about 0.1 mm and about 10 mm directed from one end of the roughened portion of the membrane.

18. The method of claim 17, wherein the at least one surface portion is adapted to have roughness (Ra) of between about 7 μm and 700 μm.

19. The method of claim 18, wherein the at least one surface portion is roughened to define an elevated or a corrugated pattern.

20. The method of claim 19, wherein the elevated portion has fixed periodicity.

21. The method of claim 19, wherein the corrugated pattern defines a sinusoidal cross section.

22. The method of claim 18, wherein the step of roughening comprises adding a membrane material to the at least one surface portion, removing surface material from the at least one surface portion, or a combination comprising the foregoing.

23. The method of claim 22, wherein the step of roughening comprises coupling a different material than the membrane material, addition of organic or inorganic nanomaterials, or a combination thereof.

24. The method of claim 21, wherein the corrugation is adapted to form channels in parallel to the direction the bubbles and/or particles scour the roughened portion of the membrane.

25. The method of claim 17, wherein the bubbles are air bubbles, CO₂ bubbles, N₂ bubbles, O₂ bubbles or a gas comprising one or more of the foregoing.

26. The method of claim 17, wherein the particle is a glass bead, silica, dust, plastic, polymer, porous particles, rubber, latex or a combination of particles comprising the foregoing.

27. The method of claim 17, wherein the performance parameter is increased flow rate, increasing time between cleanings, increasing membrane stiffness, inhibiting caking, increasing membrane permeability, giving better utilization or effectiveness of mechanical cleaning methods or a combination thereof.
